(19) United States
(12) Patent Application Publication
(10) Pub. No.: US 2019/0278583 A1
(43) Pub. Date: Sep. 12, 2019

(54) METHOD FOR UPDATING FIRMWARE, TERMINAL AND COMPUTER READABLE NON-VOLATILE STORAGE MEDIUM

(71) Applicant: PAX COMPUTER TECHNOLOGY (SHENZHEN) CO., LTD, Shenzhen, Guangdong (CN)

(72) Inventors: Heyu Nie, Shenzhen, Guangdong (CN); Shaohai Liu, Shenzhen, Guangdong (CN)

(21) Appl. No.: 16/348,710

(22) PCT Filed: Aug. 30, 2017
(86) PCT No.: PCT/CN2017/099741

§ 371 Date: May 9, 2019

(30) Foreign Application Priority Data
Mar. 30, 2017 (CN) 201710203654.8

(51) Int. Cl. G06F 8/65; G06F 13/10; G06F 21/57

(52) U.S. Cl. CPC G06F 8/65; G06F 21/572; G06F 13/102

(57) ABSTRACT

The present application relates to a method for upgrading firmware, which includes: reading a preset firmware upgrade file and mapping the preset firmware upgrade file into a memory; acquiring a function entry address of the preset firmware upgrade file; acquiring firmware upgrade data from the preset firmware upgrade file in the memory according to the function entry address; and writing the firmware upgrade data into a firmware module corresponding to the preset firmware upgrade file according to a pre-stored firmware upgrade protocol corresponding to the firmware upgrade data in the preset firmware upgrade file.

### CROSS-REFERENCE OF RELATED APPLICATION

The present application claims the priority of the Chinese patent application submitted to the Chinese Patent Office on Mar. 30, 2017 with application No. 201710203654.8, and entitled “method and device for updating firmware”, which is incorporated in the present application by reference in its entity.

### TECHNICAL FIELD

The present application relates to the technical field of computers, and in particularly to a method for updating firmware, a terminal and a computer readable non-volatile storage medium.

### BACKGROUND

Firmware refers to a “driver” stored inside a device. Through the firmware, an operating system can implement a specific machine operation according to the standard device driver. For example, the terminal of the POS (Point Of Sale) is provided with firmware such as a WiFi module driver, a magnetic card sensing module driver, etc. The traditional method for upgrading firmware is to integrate firmware upgrading function into the operating system and complete the upgrade with the operating system.

However, the traditional method for upgrading firmware makes it impossible for a user to select the upgrade for a single firmware, and frequent upgrade for the operating system brings inconvenience to the user.

### SUMMARY

According to various embodiments of the present application, a method for upgrading firmware, a terminal and a computer readable non-volatile storage medium are provided.

A method for upgrading firmware, including:

reading a preset firmware upgrade file and mapping the preset firmware upgrade file into a memory;

acquiring a function entry address of the preset firmware upgrade file;

acquiring firmware upgrade data from the preset firmware upgrade file in the memory according to the function entry address; and

writing the firmware upgrade data into a firmware module corresponding to the preset firmware upgrade file according to a pre-stored firmware upgrade protocol corresponding to the firmware upgrade data in the preset firmware upgrade file.

A terminal including a memory and a processor, the memory is stored with a computer readable instruction, and the computer readable instruction, when executed by the processor, enables the processor to implement the following steps of:

reading a preset firmware upgrade file and mapping the preset firmware upgrade file into a memory;

acquiring a function entry address of the preset firmware upgrade file;

acquiring firmware upgrade data from the preset firmware upgrade file in the memory according to the function entry address; and

writing the firmware upgrade data into a firmware module corresponding to the preset firmware upgrade file according to a pre-stored firmware upgrade protocol corresponding to the firmware upgrade data in the preset firmware upgrade file.

One or more computer readable non-volatile storage media stored with a computer readable instruction, wherein the computer readable instruction, when executed by one or more processors, enables the one or more processors to implement the following steps of:

reading a preset firmware upgrade file and mapping the preset firmware upgrade file into a memory;

acquiring a function entry address of the preset firmware upgrade file;

acquiring firmware upgrade data from the preset firmware upgrade file in the memory according to the function entry address; and

writing the firmware upgrade data into a firmware module corresponding to the preset firmware upgrade file according to a pre-stored firmware upgrade protocol corresponding to the firmware upgrade data in the preset firmware upgrade file.

Details of the one or more embodiments of the present application are set forth in the accompanying drawings and description below. Other features and advantages of the present application will be apparent from the description, drawings and claims.

### DESCRIPTION OF THE DRAWINGS

In order to more clearly illustrate the technical solutions of the embodiments of the present application, the drawings used in the embodiments will be briefly described below. It is obvious that the drawings in the following description are only some embodiments of the present application, and other drawings may be acquired based on these drawings without any creative effort for one of ordinary skill in the art.

FIG. 1 is a diagram of an internal structure of a terminal in an embodiment.

FIG. 2 is a flowchart of a method for updating firmware in an embodiment.

FIG. 3 is a flowchart of a method for verifying security of a preset firmware upgrade file in an embodiment.

FIG. 4 is a flowchart of a method for acquiring firmware upgrade data of FIG. 2 in an embodiment.

FIG. 5 is a flowchart of a method for writing firmware upgrade data of FIG. 2 in an embodiment.

FIG. 6 is flowchart of the method for updating firmware in another embodiment.

FIG. 7 is a structural block diagram of a terminal in an embodiment.

FIG. 8 is a structural block diagram of the terminal in another embodiment.

### DETAILED DESCRIPTION

In order to make the purpose, technical solutions and advantages of the present application more comprehensible, the present application will be further described in detail below with reference to the accompanying drawings and embodiments. It should be understood that the specific embodiments described herein are merely to illustrate the present application and are not intended to be limiting.

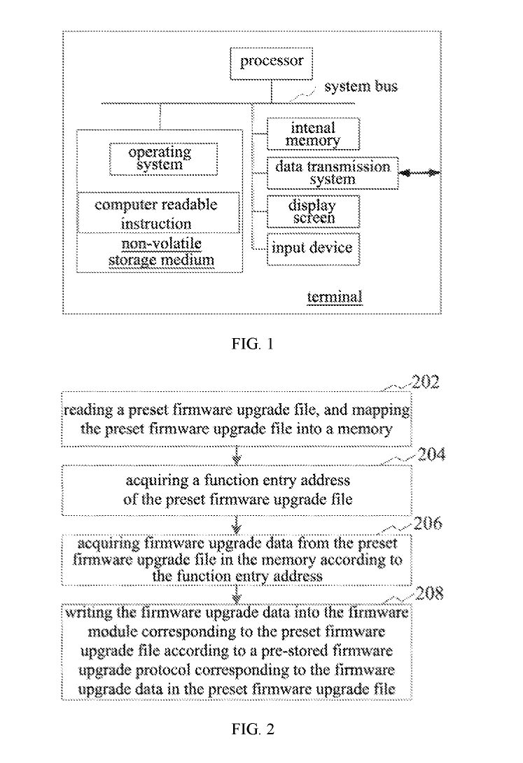

FIG. 1 is a schematic structural diagram of a terminal in an embodiment. As shown in FIG. 1, the terminal includes a processor, a non-volatile storage medium, an internal memory, a data transmission interface, a display screen, and an input device connected through a system bus. Where, the non-volatile storage medium of the terminal is stored with operating system readable instructions and a computer readable instruction, and the computer readable instruction is executed by the processor to implement a method for upgrading firmware. The processor is configured to provide computing and control capabilities to support the operation of the entire terminal. The data transmission interface is configured to communicate with other mobile storage devices. The display screen of the terminal may be a liquid crystal display or an electronic ink display screen or the like, and the input device may be a touch layer covered on the display screen, or may be a button provided on a housing of the terminal. In this embodiment, the terminal is a POS terminal (POS, Point Of Sale). A person skilled in the art will understand that the structure as shown in FIG. 1 is only a block diagram of partial structure related to the solution of the present application, and does not constitute a limitation on the terminal to which the solution of the present application is applied. Specifically, the terminal may include more or fewer components as shown in the figure, or combine some components, or have different component arrangements.

In an embodiment, as shown in FIG. 2, a method for upgrading firmware is provided. The method is illustrated by being applied to the terminal as shown in FIG. 1, and includes:

At the step 202, reading a preset firmware upgrade file, and mapping the preset firmware upgrade file into a memory.

Among them, the preset firmware upgrade file is a pre-compiled executable file with a specific type. Since the executable file is usually stored on a storage medium such as a hard disk or Nand Flash, the computer cannot directly run the executable file on these storage media, so the executable file needs to be mapped into the memory to be run.

Specifically, the process of reading the preset firmware upgrade file and mapping the preset firmware upgrade file into the memory includes: reading a file with the same file type as the preset firmware upgrade file in a terminal operating system; determining whether the read file is valid if a read result is not empty; acquiring a mapping address by parsing a file header of the read file if the read file is valid, and then mapping into the memory according to the mapping address. Where, the file type may be determined based on a file extension. Whether the file is valid may be determined by comparing a corresponding value of a file identifier stored in the file header with a valid value of a pre-stored file identifier, and the file is valid if the corresponding value of the file identifier stored in the file header is consistent with the valid value of the pre-stored file identifier, otherwise the file is invalid; whether the file is valid may also be determined by comparing a file name stored in the file header with a file name read according to the file type, and the file is valid if the file name stored in the file header is consistent with the file name read according to the file type, otherwise the file is invalid.

At the step 204: acquiring a function entry address of the preset firmware upgrade file.

The function entry address is a storage address of the function. In this embodiment, the function entry address of the preset firmware upgrade file is the storage address of the firmware upgrade function in the preset firmware upgrade file. The file header of the preset firmware upgrade file contains the function entry address of a firmware upgrade program, therefore, the function entry address may be acquired by parsing the header of the preset firmware upgrade file.

At the step 206: acquiring firmware upgrade data from the preset firmware upgrade file in the memory according to the function entry address.

Specifically, the terminal operating system first acquires information about a firmware module corresponding to the preset firmware upgrade file, which includes a model number of the firmware module and a current version number of the firmware corresponding to the model number of the firmware module, and then invokes a preset firmware upgrade function in the preset firmware upgrade file stored in the memory according to the function entry address acquired at the step 204, and passes the above firmware module information as a function parameter to the preset firmware upgrade function, so that the received current version number of the firmware corresponding to the model number of the firmware module is compared with a pre-stored version number of the firmware (i.e., a upgrade version number of the preset firmware upgrade file) by the preset firmware upgrade function. If the received current version number of the firmware corresponding to the model number of the firmware module is greater than the pre-stored version number of the firmware, then the terminal operating system acquires the firmware upgrade data corresponding to the model number of the firmware module in the firmware upgrade function.

It should be noted that, in this embodiment, whether the firmware is upgraded is determined by comparing the version number of the firmware. In other embodiments, whether the firmware is upgraded may be determined by comparing generation time of the firmware upgrade file.

At the step 208: writing the firmware upgrade data into the firmware module corresponding to the preset firmware upgrade file according to a pre-stored firmware upgrade protocol corresponding to the firmware upgrade data in the preset firmware upgrade file.

The pre-stored firmware upgrade protocol is a rule and convention pre-stored in the preset firmware upgrade file and configured for communication between the firmware module and the terminal CPU. The pre-stored firmware upgrade protocol includes a handshake protocol and a communication protocol, the handshake protocol is configured for establishing a connection before the firmware module communicates with the CPU provided by the terminal operating system, and the communication protocol is configured for data interaction in the communication between the firmware module and the CPU provided by the terminal operating system.

Specifically, after the terminal operating system acquires the firmware upgrade data corresponding to the model number of the firmware module, the communication connection, provided by the terminal operating system, between the CPU and the firmware module is first established according to the handshake protocol, and then the firmware upgrade data is written into its corresponding firmware upgrade module by following a data interaction sequence of the communication protocol to complete the firmware upgrade.

In this embodiment, since the preset firmware upgrade file is stored with the entry address of the firmware upgrade function, the terminal operating system invokes the firmware upgrade function in the preset firmware upgrade file through the entry address to acquire the firmware upgrade data in the firmware upgrade function, and then writes the firmware upgrade data into the firmware module corresponding to the preset firmware upgrade file according to the pre-stored firmware upgrade protocol corresponding to the firmware upgrade data in the preset firmware upgrade file, such that the firmware upgrade no longer depends on the upgrade of the operating system, which enables a separate upgrade for the firmware, and reduces frequent upgrades of the operating system due to the firmware upgrade in a traditional method for updating firmware, thereby improving the convenience for the firmware upgrade. Additionally, the firmware upgrade function is directly invoked through the entry address of the firmware upgrade function, which avoids running addressing codes in the conventional address mapping and improves the execution efficiency of the method for upgrading firmware.

In an embodiment, before the step of mapping the preset firmware upgrade file into the memory, the method further includes: verifying security of the preset firmware upgrade file. The step of mapping the preset firmware upgrade file into the memory is performed if the preset firmware upgrade file is verified as secure. In this embodiment, the step of security verification is added for the preset firmware upgrade file, thus ensuring the security of the firmware upgrade data.

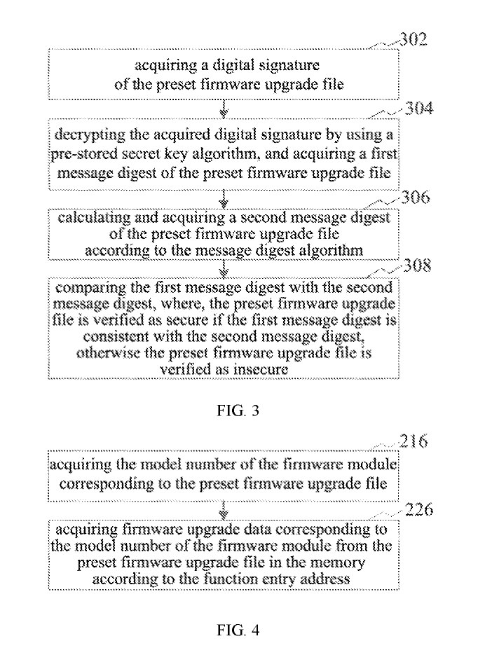

In an embodiment, as shown in FIG. 3, the step of verifying the security of the preset firmware upgrade file includes:

At the step 302: acquiring a digital signature of the preset firmware upgrade file. The digital signature is some data attached to a data unit, or a cryptographic transformation performed for the data unit. This kind of data and transformation allows a receiver of the data unit to confirm source of the data unit and integrity of the data unit, and to protect the data so as to prevent being forged by a person (such as the receiver).

In this embodiment, the digital signature of the preset firmware upgrade file is the last 256 bytes in the preset firmware upgrade file. Therefore, it would be feasible to just read a character string of the last 256 bytes of the preset firmware upgrade file.

At the step 304: decrypting the acquired digital signature by using a pre-stored secret key algorithm, and acquiring a first message digest of the preset firmware upgrade file.

The pre-stored secret key algorithm is an algorithm pre-stored in the terminal system and configured for encryption or decryption. The message digest is also referred to as a digital digest, which is a value unique to a fixed-length of a message or text. The message digest digests a plaintext that needs to be encrypted into a string of 128-bit ciphertext by using a mono-directional hash function, and this string of ciphertext is also referred to as a digital fingerprint (Finger Print) with a fixed length. Moreover, the results for digesting different plaintexts into ciphertexts are always different, and the same plaintext must have the same digest. In this embodiment, after the digital signature of the preset firmware upgrade file is acquired, the first message digest is acquired by using the digital signature decrypted and acquired through the secret key algorithm (such as a RSA algorithm) pre-stored in the current system.

At the step 306: calculating and acquiring a second message digest of the preset firmware upgrade file according to the message digest algorithm.

The message digest algorithm is also referred to as the hash algorithm, which is a very important branch of the cryptography algorithm, and extracts fingerprint information from all data to realize data signature and data integrity verification. The message digest algorithm may be a cyclic redundancy check (CRC, including CRC8, CRC16 and CRC32) algorithm, a secure hash algorithm (SHA, including SHA1, SHA256, SHA384, SHA512) or a message digest algorithm (including MD2, MD4, MD5) and the like.

Specifically, the plaintext message in the preset firmware upgrade file is transformed, by using the message digest algorithm, into a fixed-length hash value, that is, a second message digest.

At the step 308: comparing the first message digest with the second message digest, where, the preset firmware upgrade file is verified as secure if the first message digest is consistent with the second message digest, otherwise the preset firmware upgrade file is verified as insecure.

In this embodiment, the message digest acquired by decrypting the digital signature of the preset firmware upgrade file through the pre-stored secret key algorithm is compared with the message digest acquired by transforming the plaintext information in the preset firmware upgrade file through the message digest algorithm, so as to verify the security of the preset firmware upgrade file.

In an embodiment, as shown in FIG. 4, the foregoing step 206 includes: At the step 216: acquiring the model number of the firmware module corresponding to the preset firmware upgrade file.

In this embodiment, the preset firmware upgrade file is stored with firmware upgrade data for model numbers of a plurality of firmware modules, such as the upgrade data corresponding to the WiFi firmware modules respectively with the model numbers 8188ETV, 8188EUS, 8189ETV, and 8723BU.

At the step 226: acquiring firmware upgrade data corresponding to the model number of the firmware module from the preset firmware upgrade file in the memory according to the function entry address.

Specifically, the terminal operating system invokes the firmware upgrade function in the preset firmware upgrade file stored in the memory according to the function entry address of the preset firmware upgrade file, and transmits the model number of the firmware module corresponding to the preset firmware upgrade file as a function parameter to a firmware upgrade function, such that the terminal operating system acquires the firmware upgrade data corresponding to the model number of the firmware module in the preset firmware upgrade function.

In this embodiment, the terminal operating system acquires the firmware upgrade data corresponding to the model number of the firmware module in the preset firmware upgrade function, such that a same one preset firmware upgrade file supports the firmware with different model numbers to upgrade.

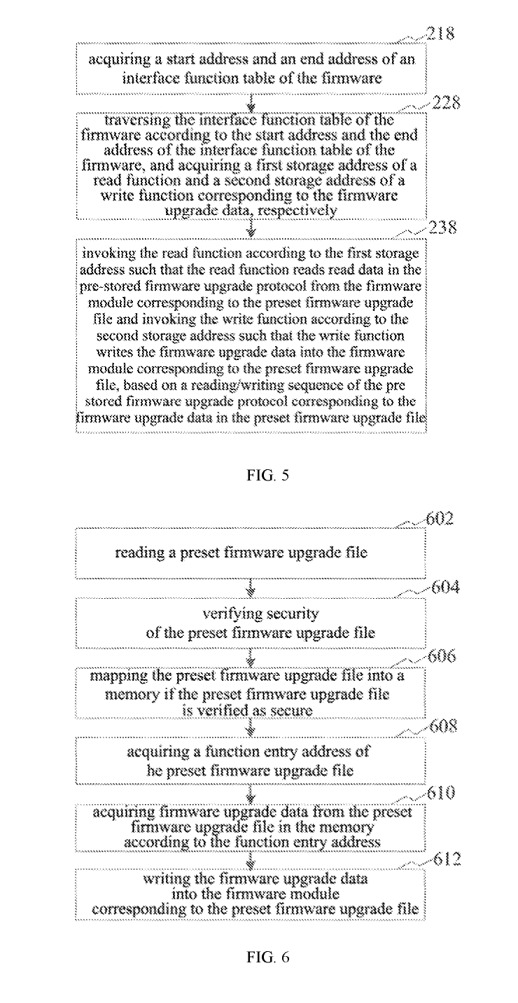

In an embodiment, as shown in FIG. 5, the foregoing step 208 includes:

At the step 218: acquiring a start address and an end address of an interface function table of the firmware.

The interface function table of the firmware is stored in the program of the operating system and is a mapping table between the interface functions communicating with the firmware module in the terminal and the storage addresses of the interface functions. Moreover. In this embodiment, the terminal operating system determines the location of the function table by acquiring the start address and the end address of the interface function table of the firmware for storage.

At the step 228, traversing the interface function table of the firmware according to the start address and the end address of the interface function table of the firmware, and acquiring a first storage address of a read function and a second storage address of a write function corresponding to the firmware upgrade data, respectively.

In this embodiment, the read function reads data required for the upgrade from the firmware module corresponding to the firmware upgrade data, and the write function is a function configured for writing the firmware upgrade data into the firmware module corresponding thereto. For example, a WiFiRead function is configured to read the data required for the upgrade from a WIFI firmware, and a WiFiWrite function is configured to write WIFI firmware data into a WIFI communication module.

Since the interface function table of the firmware is stored in the program of the operating system and is a mapping table between the interface functions communicating with the firmware module in the terminal and the storage addresses of the interface functions, the storage address for a desired function may be looked up in the interface function table of the firmware after the specific location of the interface function table of the firmware is determined.

At the step 238, invoking the read function according to the first storage address such that the read function reads read data in the pre-stored firmware upgrade protocol from the firmware module corresponding to the preset firmware upgrade file and invoking the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

Specifically, the pre-stored firmware upgrade protocol corresponding to the firmware upgrade data in the preset firmware upgrade file is parsed to acquire the handshake protocol and the communication protocol. Firstly, the communication connection, provided by the terminal operating system, between the CPU and the firmware module is established according to the handshake protocol, and then the data in the communication protocol is read. Further, if there is an identifier for the read operation, the read data corresponding to the identifier for the read operation is acquired and the read data is transmitted to the read function through the first storage address, such that the read function reads the read data from the firmware module corresponds to the preset firmware upgrade file, and the data in the communication protocol is further read if the data is successfully read from the firmware module. If there is an identifier for the write operation, the firmware upgrade data is transmitted to the write function through the second storage address, such that the write function writes the firmware upgrade data into the firmware module corresponding to the preset firmware upgrade file, and the data in the communication protocol is further read until all the data in the communication protocol is read if the write function is successfully written to the firmware module. In an embodiment, as shown in FIG. 6, another method for upgrading firmware is provided, which, illustrated by taking the method for upgrading WIFI firmware applied to the POS terminal as an example, includes:

At the step 602: reading a preset firmware upgrade file.

In this embodiment, the preset firmware upgrade file is a file with type MPATCH compiled by compiling software, the file name of which is WIFIMpatch.

Specifically, the file with the extension MPATCH is traversed and looked up in the file system of the POS terminal. If the file with the extension MPATCH is found, the file name of the file is acquired and the file header of the file is parsed to acquire a value of the element Name, and then the value of Name is compared with the file name. If the comparison result is consistent, the found file is a valid file, i.e., the preset firmware upgrade file.

At the step 604, verifying security of the preset firmware upgrade file.

Specifically, last 256-byte signature information of the preset firmware upgrade file is read, and then a first message digest is acquired by using a RSA public key pre-stored in a POS machine to decrypt the signature information, next a message digest algorithm is configured to compute and acquire a second message digest of the found MPATCH file, finally the first message digest is compared with the second message digest, and it is verified as secure if the comparison result is consistent, otherwise it is verified as insecure.

At the step 606: mapping the preset firmware upgrade file into a memory if the preset firmware upgrade file is verified as secure.

Specifically, the file header of the found MPATCH file is parsed, a mapping address for mapping the preset firmware upgrade file into the memory is acquired, and then a function segment and a variable segment in the MPATCH file are copied to the mapping address in the memory.

At the step 608: acquiring a function entry address of the preset firmware upgrade file.

In this embodiment, the function entry address of the firmware upgrade function is acquired through parsing the file header of the preset firmware upgrade file.

At the step 610: acquiring firmware upgrade data from the preset firmware upgrade file in the memory according to the function entry address.

In this embodiment, the POS terminal operating system first acquires information about the firmware module (including a model number of the firmware module, a current version number of the firmware corresponding to the model number of the firmware module) corresponding to the upgrade file of the preset upgrade firmware, and then invokes a preset firmware upgrade function in the memory according to the acquired function entry address, and transmits the information about the firmware module as a function parameter to the preset firmware upgrade function, such that the preset firmware upgrade function compares the received current version number of the firmware corresponding to the model number of the firmware module with a pre-stored version number of the firmware (that is, an upgrade version number of the preset firmware upgrade file). If the received current version number of the firmware corresponding to the model number of the firmware module is greater than the pre-stored version number of the firmware, then the terminal operating system acquires the firmware upgrade data corresponding to the model number of the firmware module in the firmware upgrade function.

At the step 612, writing the firmware upgrade data into the firmware module corresponding to the preset firmware upgrade file.

Specifically, the POS terminal operating system first acquires a start address and an end address stored in an interface function table of the firmware, and then traverses the interface function table of the firmware according to the start address and the end address of the interface function table of the firmware, and respectively acquires a first storage address of the read function (WiFiRead) and a second storage address of the write function (WiFiWrite) corresponding to the firmware upgrade data, next parses a pre-stored firmware upgrade protocol corresponding to the firmware upgrade data in the preset firmware upgrade file to acquire a handshake protocol and a communication protocol. The communication connection, provided by the POS terminal operating system, between the CPU and the firmware module is established according to the handshake protocol, and the data in the communication protocol is read if the connection is successfully established. If there is an identifier for a read operation, the read data corresponding to the identifier for the read operation is acquired, and the read data is transmitted to the read function (WiFiRead) through the first storage address such that the read function reads the read data from the firmware module corresponding to the preset firmware upgrade file, and the data in the communication protocol is further read if the data is successfully read from the firmware module. If there is an identifier for a write operation, the firmware upgrade data is transmitted to the write function (WiFiWrite) through the second storage address such that the write function writes the firmware upgrade data into the firmware module corresponding to the preset firmware upgrade file, and the data in the communication protocol is further read until all the data in the communication protocol has been read if the write function is successfully written into the firmware module.

In this embodiment, the firmware upgrade function in the preset firmware upgrade file is invoked through the entry address to acquire the firmware upgrade data in the firmware upgrade function, and then the firmware upgrade data is written into the firmware module corresponding to the preset firmware upgrade file according to the pre-stored data protocol for the firmware upgrade corresponding to the firmware upgrade data in the preset firmware upgrade file, such that the firmware upgrade no longer depends on the upgrade of the operating system, which enables a separate upgrade for the firmware, and reduces frequent upgrades of the operating system due to the firmware upgrade in a traditional method for updating firmware, thereby improving the convenience for the firmware upgrade. Additionally, the firmware upgrade function is directly invoked through the entry address of the firmware upgrade function, which avoids running addressing codes in the conventional address mapping and improves the execution efficiency of the method for upgrading firmware. Further, the step of verifying security is added for the preset firmware upgrade file, which ensures the security of the firmware upgrade data.

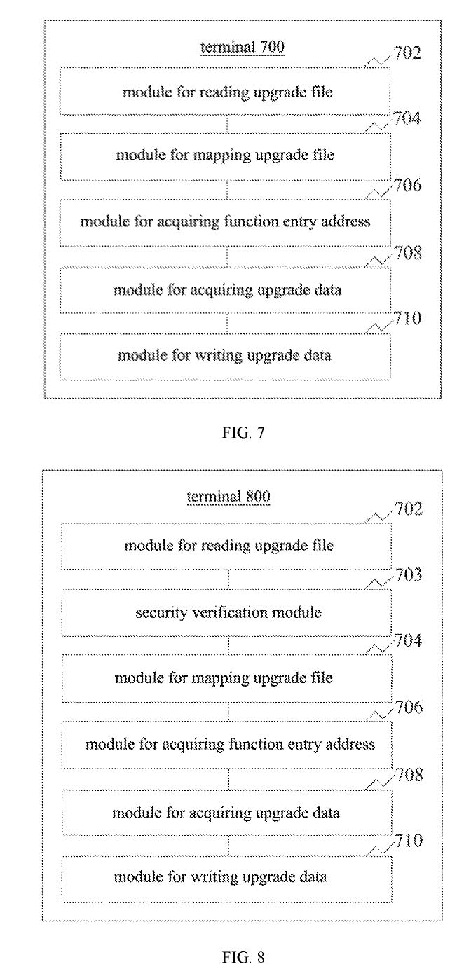

In an embodiment, as shown in FIG. 7, a structural block diagram of a terminal 700 is provided. The internal structure of the terminal may be referred to the terminal as shown in FIG. 2. Each of the modules described below may be implemented in whole or in part through software, hardware or a combination thereof.

Referring to FIG. 7, the terminal 700 includes:

a module 702 for reading upgrade file configured to read a preset firmware upgrade file;

a module 704 for mapping upgrade file configured to map the preset firmware upgrade file into a memory;

a module 706 for acquiring function entry address configured to acquire a function entry address of the preset firmware upgrade file;

a module 708 for acquiring upgrade data configured to acquire firmware upgrade data from the preset firmware upgrade file in the memory according to the function entry address; and

a module 710 for writing upgrade data configured to write the firmware upgrade data into a firmware module corresponding to the preset firmware upgrade file according to a pre-stored firmware upgrade protocol corresponding to the firmware upgrade data in the preset firmware upgrade file.

In an embodiment, as shown in FIG. 8, the terminal 800 further includes a security verification module 703 configured to verify security of the preset firmware upgrade file. The module 704 for mapping upgrade file is configured to perform a step of mapping the preset firmware upgrade file into the memory if the preset firmware upgrade file is verified as secure.

In an embodiment, the security verification module 703 is configured to acquire digital signature information of the preset firmware upgrade file; to decrypt the acquired digital signature by using a pre-stored secret key algorithm to acquire a first message digest of the preset firmware upgrade file; to compute and acquire a second message digest of the preset firmware upgrade file according to a message digest algorithm; and to compare the first message digest with the second message digest. The preset firmware upgrade file is verified as security if the first message digest is consistent with the second message digest, otherwise the preset firmware upgrade file is verified as insecure.

In an embodiment, the module 708 for acquiring upgrade data is configured to acquire a model number of the firmware module corresponding to the preset firmware upgrade file; and to acquire firmware upgrade data corresponding to the model number of the firmware module from the preset firmware upgrade file in the memory according to the function entry address.

In an embodiment, the module 710 for writing upgrade data is configured to acquire a start address and an end address of an interface function table of the firmware; to traverse the interface function table of the firmware according to the start address and the end address of the interface function table of the firmware, and to respectively acquire a first storage address of a read function and a second storage address of a write function corresponding to the firmware upgrade data; and to invoke the read function according to the first storage address such that the read function reads read data in the pre-stored firmware upgrade protocol from the firmware module corresponding to the preset firmware upgrade file and to invoke the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

An embodiment of the present application further provides a computer device. The computer device includes a memory, a processor, and a computer program stored on the memory and executable by the processor, the processor, when executing the program, implements the steps from 302 to 308 described above.

In an embodiment, the processor, when executing the program, further implements the following steps of: verifying security of the preset firmware upgrade file; and performing the steps of mapping the preset firmware upgrade file into the memory if the preset firmware upgrade file is verified as secure.

In an embodiment, the processor, when executing the program, further implements the following steps of: acquiring a digital signature of the preset firmware upgrade file; decrypting the acquired digital signature by using a pre-stored secret key algorithm, and acquiring a first message digest of the preset firmware upgrade file; calculating and acquiring a second message digest of the preset firmware upgrade file according to a message digest algorithm; and comparing the first message digest with the second message digest, where, the preset firmware upgrade file is verified as secure if the first message digest is consistent with the second message digest, otherwise the preset firmware upgrade file is verified as insecure.

In an embodiment, the processor, when executing the program, further implements the following steps of: acquiring a model number of the firmware module corresponding to the preset firmware upgrade file; and acquiring firmware upgrade data corresponding to the model number of the firmware module from the preset firmware upgrade file in the memory according to the function entry address.

In an embodiment, the processor, when executing the program, further implements the following steps of: acquiring a start address and an end address of an interface function table of the firmware; traversing the interface function table of the firmware according to the start address and the end address of the interface function table of the firmware, and acquiring a first storage address of a read function and a second storage address of a write function corresponding to the firmware upgrade data, respectively; and invoking the read function according to the first storage address such that the read function reads read data in the pre-stored firmware upgrade protocol from the firmware module corresponding to the preset firmware upgrade file and invoking the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

In an embodiment, one or more computer readable non-volatile storage media stored with a computer readable instruction are provided, the computer readable instruction, when executed by one or more processors, enables the one or more processors to implement the following steps of:

reading a preset firmware upgrade file and mapping the preset firmware upgrade file into a memory;

acquiring a function entry address of the preset firmware upgrade file;

acquiring firmware upgrade data from the preset firmware upgrade file in the memory according to the function entry address; and

writing the firmware upgrade data into a firmware module corresponding to the preset firmware upgrade file according to a pre-stored firmware upgrade protocol corresponding to the firmware upgrade data in the preset firmware upgrade file.

In an embodiment, the step, executed by the processors, of mapping the preset firmware upgrade file into the memory includes: verifying security of the preset firmware upgrade file; and mapping the preset firmware upgrade file into the memory if the preset firmware upgrade file is verified as secure.

In an embodiment, the step, executed by the processors, of verifying the security of the preset firmware upgrade file includes: acquiring a digital signature of the preset firmware upgrade file; decrypting the acquired digital signature by using a pre-stored secret key algorithm, and acquiring a first message digest of the preset firmware upgrade file; calculating and acquiring a second message digest of the preset firmware upgrade file according to a message digest algorithm; and comparing the first message digest with the second message digest, where, the preset firmware upgrade file is verified as secure if the first message digest is consistent with the second message digest, otherwise the preset firmware upgrade file is verified as insecure.

In an embodiment, the step, executed by the processors, of acquiring firmware upgrade data from the preset firmware upgrade file in the memory according to the function entry address includes: acquiring a model number of a firmware module corresponding to the preset firmware upgrade file; and acquiring firmware upgrade data corresponding to the model number of the firmware module from the preset firmware upgrade file in the memory according to the function entry address.

In an embodiment, the step, executed by the processors, of writing the firmware upgrade data into the firmware module corresponding to the preset firmware upgrade file according to a pre-stored firmware upgrade protocol corresponding to the firmware upgrade data in the preset firmware upgrade file includes: acquiring a start address and an end address of an interface function table of the firmware; traversing the interface function table of the firmware according to the start address and the end address of the interface function table of the firmware, and acquiring a first storage address of a read function and a second storage address of a write function corresponding to the firmware upgrade data, respectively; and invoking the read function according to the first storage address such that the read function reads read data in the pre-stored firmware upgrade protocol from the firmware module corresponding to the preset firmware upgrade file and invoking the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

In an embodiment, the step, executed by the processors, of reading the preset firmware upgrade file and mapping the preset firmware upgrade file into the memory includes: reading a file with the same file type as the preset firmware upgrade file in a terminal operating system; determining whether the read file is valid if a read result is not empty; acquiring a mapping address by parsing a file header of the read file if the read file is valid, and then mapping into the memory according to the mapping address.

It should be noted that, the “first” and “second” in each of the embodiments of the present application are only used as a distinction, and are not used as a limitation on size, subordination, sequence and the like.

The technical features of the above-described embodiments may be arbitrarily combined. For the sake of brevity of description, all possible combinations of the technical features in the above embodiments are not described completely. However, as long as there is no contradiction between the combinations of these technical features, they should be considered within the scope of this specification.

The above-mentioned embodiments merely illustrate several embodiments of the present application, the description of which is relatively specific and detailed, and is not to be construed as limiting the scope of the application. It should be noted that, various variations and modifications may be made by those of ordinary skill in the art without departing from the conception of the present application, which are all within the scope of the present application. Therefore, the scope of the present application should be determined by the appended claims.

What is claimed is:

1. A method for upgrading firmware, comprising:
reading a preset firmware upgrade file and mapping the preset firmware upgrade file into a memory;
acquiring a function entry address of the preset firmware upgrade file;
acquiring firmware upgrade data from the preset firmware upgrade file in the memory according to the function entry address; and
writing the firmware upgrade data into a firmware module corresponding to the preset firmware upgrade file according to a pre-stored firmware upgrade protocol corresponding to the firmware upgrade data in the preset firmware upgrade file.

2. The method according to claim 1, wherein, before mapping the preset firmware upgrade file into the memory, the method further comprises:
verifying security of the preset firmware upgrade file; and
performing the step of mapping the preset firmware upgrade file into the memory if the preset firmware upgrade file is verified as secure.

3. The method according to claim 2, wherein, the step of verifying the security of the preset firmware upgrade file comprises:
acquiring a digital signature of the preset firmware upgrade file;
decrypting the acquired digital signature by using a pre-stored secret key algorithm, and acquiring a first message digest of the preset firmware upgrade file;
calculating and acquiring a second message digest of the preset firmware upgrade file according to a message digest algorithm; and
comparing the first message digest with the second message digest, wherein the preset firmware upgrade file is verified as secure if the first message digest is consistent with the second message digest, otherwise the preset firmware upgrade file is verified as insecure.

4. The method according to claim 1, wherein, the step of acquiring the firmware upgrade data from the preset firmware upgrade file in the memory according to the function entry address comprises:
acquiring a model number of the firmware module corresponding to the preset firmware upgrade file; and
acquiring firmware upgrade data corresponding to the model number of the firmware module from the preset firmware upgrade file in the memory according to the function entry address.

5. The method according to claim 1, wherein, the step of writing the firmware upgrade data into the firmware module corresponding to the preset firmware upgrade file according to the pre-stored firmware upgrade protocol corresponding to the firmware upgrade data in the preset firmware upgrade file comprises:
acquiring a start address and an end address of an interface function table of the firmware;
traversing the interface function table of the firmware according to the start address and the end address of the interface function table of the firmware, and acquiring a first storage address of a read function and a second storage address of a write function corresponding to the firmware upgrade data, respectively; and
invoking the read function according to the first storage address such that the read function reads read data in the pre-stored firmware upgrade protocol from the firmware module corresponding to the preset firmware upgrade file and invoking the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

6. The method according to claim 1, wherein, the step of reading the preset firmware upgrade file and mapping the preset firmware upgrade file into the memory comprises:
reading a file with the same file type as the preset firmware upgrade file in a terminal operating system;
determining whether the read file is valid if a read result is not empty; and
acquiring a mapping address by parsing a file header of the read file if the read file is valid, and then mapping into the memory according to the mapping address.

7. A terminal, comprising a memory and a processor, wherein the memory is stored with a computer readable instruction, and the computer readable instruction, when executed by the processor, enables the processor to implement the following steps of:
reading a preset firmware upgrade file and mapping the preset firmware upgrade file into a memory;
acquiring a function entry address of the preset firmware upgrade file;
acquiring firmware upgrade data from the preset firmware upgrade file in the memory according to the function entry address; and
writing the firmware upgrade data into a firmware module corresponding to the preset firmware upgrade file according to a pre-stored firmware upgrade protocol corresponding to the firmware upgrade data in the preset firmware upgrade file.

8. The terminal according to claim 7, wherein, the step, executed by the processor, of mapping the preset firmware upgrade file into the memory comprises:
verifying security of the preset firmware upgrade file; and
mapping the preset firmware upgrade file into the memory if the preset firmware upgrade file is verified as secure.

9. The terminal according to claim 8, wherein, the step, executed by the processor, of verifying the security of the preset firmware upgrade file comprises:
acquiring a digital signature of the preset firmware upgrade file;
decrypting the acquired digital signature by using a pre-stored secret key algorithm, and acquiring a first message digest of the preset firmware upgrade file;
calculating and acquiring a second message digest of the preset firmware upgrade file according to a message digest algorithm; and
comparing the first message digest with the second message digest, wherein the preset firmware upgrade file is verified as secure if the first message digest is consistent with the second message digest, otherwise the preset firmware upgrade file is verified as insecure.

10. The terminal according to claim 7, wherein, the step, executed by the processor, of acquiring the firmware upgrade data from the preset firmware upgrade file in the memory according to the function entry address comprises:
acquiring a model number of the firmware module corresponding to the preset firmware upgrade file; and
acquiring the firmware upgrade data corresponding to the model number of the firmware module from the preset firmware upgrade file in the memory according to the function entry address.

11. The terminal according to claim 7, wherein, the step, executed by the processor, of writing the firmware upgrade data into the firmware module corresponding to the preset firmware upgrade file according to the pre-stored firmware upgrade protocol corresponding to the firmware upgrade data in the preset firmware upgrade file comprises:
acquiring a start address and an end address of an interface function table of the firmware;
traversing the interface function table of the firmware according to the start address and the end address of the interface function table of the firmware, and acquiring a first storage address of a read function and a second storage address of a write function corresponding to the firmware upgrade data, respectively; and
invoking the read function according to the first storage address such that the read function reads read data in the pre-stored firmware upgrade protocol from the firmware module corresponding to the preset firmware upgrade file and invoking the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

12. The terminal according to claim 7, wherein, the step, executed by the processor, of reading the preset firmware upgrade file and mapping the preset firmware upgrade file into the memory comprises:
reading a file with the same file type as the preset firmware upgrade file in a terminal operating system;
determining whether the read file is valid if a read result is not empty; and
acquiring a mapping address by parsing a file header of the read file if the read file is valid, and then mapping into the memory according to the mapping address.

13. One or more computer readable non-volatile storage media stored with a computer readable instruction, wherein the computer readable instruction, when executed by one or more processors, enables the one or more processors to implement the following steps of:
reading a preset firmware upgrade file and mapping the preset firmware upgrade file into a memory;
acquiring a function entry address of the preset firmware upgrade file;
acquiring firmware upgrade data from the preset firmware upgrade file in the memory according to the function entry address; and
writing the firmware upgrade data into a firmware module corresponding to the preset firmware upgrade file according to a pre-stored firmware upgrade protocol corresponding to the firmware upgrade data in the preset firmware upgrade file.

14. The computer readable non-volatile storage media according to claim 13, wherein, the step, executed by the processors, of mapping the preset firmware upgrade file into the memory comprises:
verifying security of the preset firmware upgrade file; and
mapping the preset firmware upgrade file into the memory if the preset firmware upgrade file is verified as secure.

15. The computer readable non-volatile storage media according to claim 14, wherein, the step, executed by the processors, of verifying the security of the preset firmware upgrade file comprises:
acquiring a digital signature of the preset firmware upgrade file;
decrypting the acquired digital signature by using a pre-stored secret key algorithm, and acquiring a first message digest of the preset firmware upgrade file;
calculating and acquiring a second message digest of the preset firmware upgrade file according to a message digest algorithm; and
comparing the first message digest with the second message digest, wherein the preset firmware upgrade file is verified as secure if the first message digest is consistent with the second message digest, otherwise the preset firmware upgrade file is verified as insecure.

16. The computer readable non-volatile storage media according to claim 13, wherein, the step, executed by the processors, of acquiring the firmware upgrade data from the preset firmware upgrade file in the memory according to the function entry address comprises:
acquiring a model number of the firmware module corresponding to the preset firmware upgrade file; and
acquiring the firmware upgrade data corresponding to the model number of the firmware module from the preset firmware upgrade file in the memory according to the function entry address.

17. The storage media according to claim 13, wherein, the step, executed by the processors, of writing the firmware upgrade data into the firmware module corresponding to the preset firmware upgrade file according to the pre-stored firmware upgrade protocol corresponding to the firmware upgrade data in the preset firmware upgrade file comprises:
acquiring a start address and an end address of an interface function table of the firmware;
traversing the interface function table of the firmware according to the start address and the end address of the interface function table of the firmware, and acquiring a first storage address of a read function and a second storage address of a write function corresponding to the firmware upgrade data, respectively; and
invoking the read function according to the first storage address such that the read function reads read data in the pre-stored firmware upgrade protocol from the firmware module corresponding to the preset firmware upgrade file and invoking the write function according to the second storage address such that the write function writes the firmware upgrade data into the firmware module corresponding to the preset firmware upgrade file, based on a reading/writing sequence of the pre-stored firmware upgrade protocol corresponding to the firmware upgrade data in the preset firmware upgrade file.

18. The computer readable non-volatile storage media according to claim 13, wherein, the step, executed by the processors, of reading the preset firmware upgrade file and mapping the preset firmware upgrade file into the memory comprises:
reading a file with the same file type as the preset firmware upgrade file in a terminal operating system;
determining whether the read file is valid if a read result is not empty; and
acquiring a mapping address by parsing a file header of the read file if the read file is valid, and then mapping into the memory according to the mapping address.
